(19) United States
(12) Patent Application Publication
(10) Pub. No.: US 2026/0121746 A1
(43) Pub. Date: Apr. 30, 2026

(54) HOLLOW CORE FIBER-BASED LINE-SYSTEM WITH OUT-OF-BAND OPTICAL SUPERVISORY CHANNEL

(71) Applicant: Microsoft Technology Licensing, LLC, Redmond, WA (US)

(72) Inventors: Matthew Artus TUGGLE, Seattle, WA (US); Abdallah Alsayed Ismail ALI, Southampton (GB); Binbin GUAN, Issaquah, WA (US); David John RICHARDSON, Southampton (GB)

(73) Assignee: Microsoft Technology Licensing, LLC, Redmond, WA (US)

(21) Appl. No.: 18/931,429

(22) Filed: Oct. 30, 2024

(51) Int. Cl. H04B 10/25

(52) U.S. Cl. CPC H04B 10/25

(57) ABSTRACT

Systems and methods are provided for implementing a hollow core fiber-based line-system with an out-of-band optical supervisory channel. A first transponder, located at a first location, transmits optical data traffic at a first wavelength range to a second transponder, at a second location, over at least one hollow core fiber (“HCF”) cable communicatively coupling the first and second transponders over a fiber path distance that is at least 60 kilometers. The first transponder further transmits an optical supervisory channel (“OSC”) signal at a second wavelength to the second transponder over the at least one HCF cable. The OSC signal corresponds to diagnostic data associated with transmission of the optical data signal and/or associated with operation of a system including the first and second transponders. The second wavelength is separate from the first wavelength range by at least a threshold wavelength separation.

### BACKGROUND

In optical networking, in addition to carrying data traffic, optical fiber cables are also used to carry an optical supervisory channel that is used for monitoring the health of the optical networking system. It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for a hollow core fiber-based line-system with an out-of-band optical supervisory channel. A first transponder, which is located at a first location, transmits an optical data signal to a second transponder at a first wavelength range within a first optical wavelength transmission band over at least one hollow core fiber (“HCF”) cable communicatively coupling the second transponder to the first transponder. The second transponder is located at a second location that is geographically separated from the first location. The first transponder further transmits an optical supervisory channel (“OSC”) signal to the second transponder at a second wavelength, within a second optical wavelength transmission band, over the at least one HCF cable communicatively coupling the second transponder to the first transponder over a first fiber path distance that is at least 60 kilometers. The OSC signal corresponds to diagnostic data associated with operation of a system including the first and second transponders and/or associated with transmission of the optical data signal. The second optical wavelength transmission band is separate from the first optical wavelength transmission band by at least a threshold wavelength separation. In this manner, with the use of the at least one HCF cable, the OSC can be operated at wavelengths sufficiently far from the traffic carrying wavelengths with the same or an almost same attenuation as the traffic carrying ranges, which significantly simplifies the overall OSC system.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing an HCF-based line-system with an out-of-band optical supervisory channel.

FIGS. 2A-2D depict cross-sectional views of various example configurations of HCF cables when implementing an HCF-based line-system with an out-of-band optical supervisory channel.

FIG. 3A depicts an example graphical representation illustrating loss measurement of an HCF compared with loss measurement of a solid core fiber, with respect to wavelength.

FIG. 3B depicts an example graphical representation illustrating resonant and anti-resonant windows.

FIGS. 4A and 4B depict an example method for implementing a hollow core fiber-based line-system with an out-of-band optical supervisory channel and an example method for selecting a wavelength over which to transmit an optical supervisory channel.

FIG. 5 depicts an example method of manufacturing a hollow core optical fiber for carrying an out-of-band optical supervisory channel.

FIG. 6 depicts a block diagram illustrating example physical components of a computing device with which aspects of the technology may be practiced.

### DETAILED DESCRIPTION OF CERTAIN EMBODIMENTS

In solid core fiber-based optical networking systems, such as an optical line system (“OLS”), in addition to carrying data traffic, solid core fiber cables are also used to carry an OSC signal that is used for monitoring the health of the optical networking system. To help distinguish the OSC signal from the data traffic, there is a benefit of having the OSC signal be communicated in a different wavelength than data traffic. With solid core fiber, however, there is a limit to the wavelength differentials that can be achieved due to attenuation. For instance, wavelengths outside of particular bands see high rates of attenuation in solid core fibers. If the loss is too high, the signal will not be detectable at either end of the system and all information carried by the OSC is lost. Increasing the optical power to try to overcome the loss results in non-linearities in solid core fibers, while signals having low optical power incur loss over solid core fibers over longer distances (e.g., greater than 60 kilometers) such as to be undetectable by a receiver over such a distance. For example, a solid core fiber with a 0.25 decibels per kilometer (dB/km) loss rating would have a loss of 15 dB over 60 km, and thus any optical signal transmitted over such a fiber over that distance that is 15 decibels milliwatt (dBm) or less would not be successfully received due to the optical signal being 0 dBm or a negative value over 60 km. For long distances, solid-core-fiber-based systems require repeaters that terminate a received signal, then reshape and regenerate the signal, so that noise can be reduced or eliminated, thus incurring additional costs in terms of equipment, installation, maintenance, and additional points of potential failure.

For data traffic being carried at a data signal wavelength of 1550 nanometers (nm), for example, the OSC wavelength for conventional solid core fiber-based systems may be near 1550 nm to minimize losses due to attenuation. Although it may be more beneficial to use OSC wavelengths at 1310 nm, for instance, the attenuation for 1310 nm is about 1.7 to 2 times more than for 1550 nm, due to an increased impact of Rayleigh scattering in the glass core of the solid core fiber at shorter wavelengths. More repeaters may be required to reduce the distances to counter the greater attenuation, which would result in increases in operational and infrastructure costs, as well as inefficiencies. In other words, either the OSC wavelengths are selected to be too close to the data traffic wavelength, which makes it difficult to distinguish between the data signals and the OSC signals, or a greater number of repeaters are required to offset greater attenuation when using a farther-apart OSC wavelength (e.g., at 1310 nm).

The present technology provides for a hollow core fiber-based line-system with an out-of-band optical supervisory channel. HCFs are not susceptible to Rayleigh scattering to the extent that solid core fibers are, due to absence of a solid glass core that increases the impact of Rayleigh scattering. As described in detail below, with the use of HCFs, the OSC can operate at wavelengths sufficiently far from the data traffic carrying wavelengths (e.g., in an optical wavelength transmission band for the OSC compared with that for the data traffic) with the same or near same attenuation as the data traffic carrying wavelength ranges, which significantly simplifies the overall OSC system. In this manner, lower loss or attenuation (e.g., 0.05 dB/km) can be achieved with OSC wavelengths being farther apart from the data traffic carrying wavelengths (e.g., about 1300 nm OSC wavelength compared with about 1550 nm data traffic carrying wavelength). In some examples, anti-resonant windows can be set to match laser wavelengths of commercially available lasers (e.g., off-the-shelf lasers), as described in detail below. Accordingly, lower operational costs may be achieved using such commercially available lasers. Overall system efficiencies can thus be achieved.

Further, unlike solid core fiber-based systems, HCF-based systems can operate at higher optical power without encountering non-linearities, and with high optical power, longer lengths (e.g., at least 60 km) of HCFs can be used. In this manner, use of repeaters is obviated over such lengths, thereby avoiding additional costs in terms of equipment, installation, maintenance, and additional points of potential failure with the use of repeaters.

Various modifications and additions can be made to the embodiments discussed herein without departing from the scope of the disclosed techniques. For example, while the embodiments described above refer to particular features, the scope of the disclosed techniques also includes embodiments having different combinations of features and embodiments that do not include all of the above-described features.

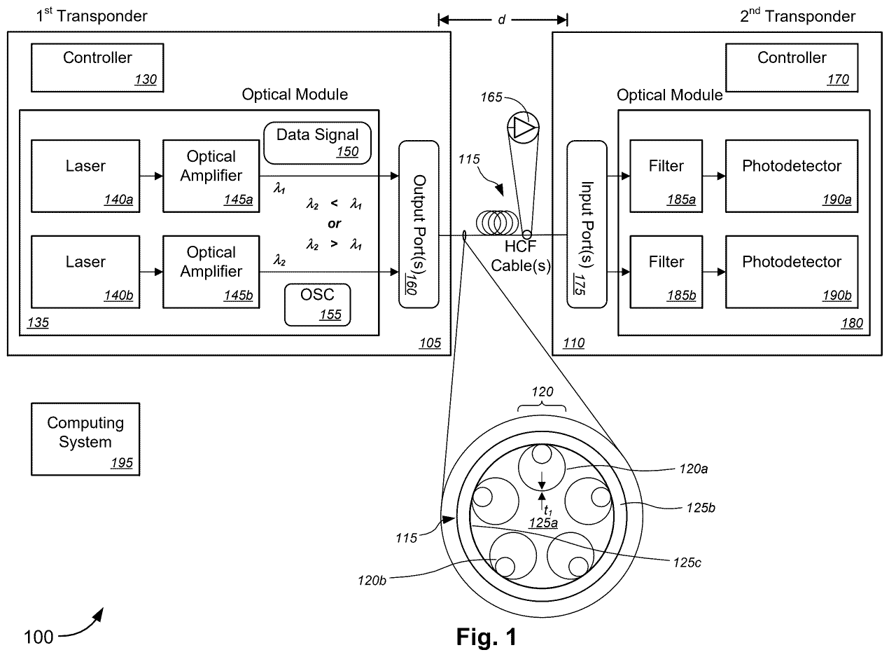

Turning to the embodiments as illustrated by the drawings, FIGS. 1-6 illustrate some of the features of methods, systems, and apparatuses for implementing an HCF-based line-system with an out-of-band optical supervisory channel, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

FIG. 1 depicts an example system 100 for implementing an HCF-based line-system with an out-of-band optical supervisory channel. With reference to FIG. 1, system 100 includes a first transponder 105 and a second transponder 110 that are communicatively coupled with each other via at least one HCF cable 115 over a fiber path distance d. In some examples, the at least one HCF cable 115 communicatively coupling the first and second transponders 105 and 110 include two or more HCF cables that are spliced together to form a spliced-together HCF cable that achieves the fiber path distance (or fiber length) d, the ends of the spliced-together HCF cable being connected to each of the first transponder 105 and the second transponder 110 via connectors. The first transponder 105 and the second transponder 110 are geographically separated from each other. In examples, the distance d is one of about 60 km, about 70 km, about 80 km, about 90 km, about 100 km, about 110 km, about 120 km, about 130 km, about 140 km, about 150 km, about 175 km, about 200 km, about 225 km, about 250 km, about 275 km, about 300 km, about 325 km, about 350 km, about 375 km, about 400 km, about 425 km, about 450 km, about 475 km, about 500 km, about 550 km, about 600 km, about 650 km, about 700 km, about 750 km, about 800 km, about 850 km, about 900 km, about 950 km, about 1000 km, or greater. In some examples, the distance d ranges from about 15 km to about 60 km, from about 60 km to about 120 km, from about 100 km to about 1000 km, from about 100 km to about 200 km, from about 200 km to about 300 km, from about 300 km to about 400 km, from about 400 km to about 500 km, from about 500 km to about 600 km, from about 600 km to about 700 km, from about 700 km to about 800 km, from about 800 km to about 900 km, from about 900 km to about 1000 km, or greater. For longer distances d (e.g., greater than 100 km) between two transponders (e.g., transponders 105 and 110), intermediate amplifiers (e.g., amplifier(s) 165) can be used between the two transponders to amplify optical signals carried by each of the at least one HCF cable 115. In examples, the first transponder 105 and the second transponder 110 are part of an optical line system (“OLS”). The OLS is an optical network system that combines multiple wavelength-specific coherent optics including multiplexers/demultiplexers, optical add-drop multiplexers (“OADMs”), reconfigurable optical add-drop multiplexers (“ROADMs”), wavelength selective switches, optical amplifiers, optical monitoring systems, and/or power management tools.

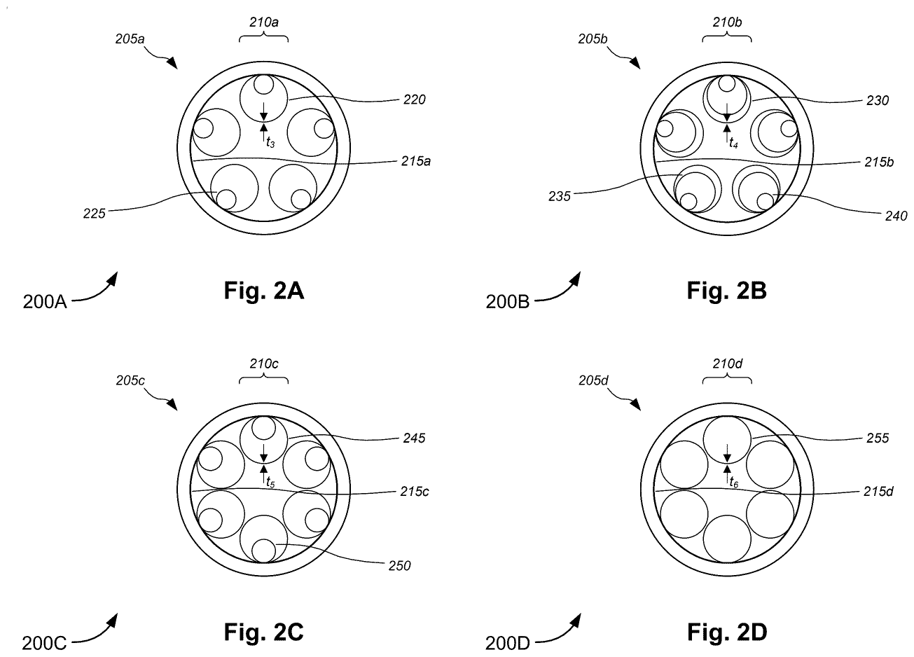

In some examples, as shown in FIG. 1 by the partial cross-section of the at least one HCF cable 115, each HCF cable 115 includes a plurality of nested tubes 120 formed within a hollow core 125a defined by a cladding 125b. In the example of FIG. 1, five sets of nested tubes 120 are formed on an inner surface 125c of the cladding 125b of the HCF cable 115. In some examples, such as shown in FIG. 1, each set of nested tubes has a hollow tube 120b nested within hollow tube 120a. Each hollow tube 120a or 120b is formed from a membrane having a thickness 11. In some cases, the thicknesses of hollow tubes 120a and 120b are the same. In other cases, the thickness of hollow tube 120a is different from the thickness of hollow tube 120b. FIGS. 2A-2D depict other example HCF cables having different example configurations of the nested tubes with corresponding membrane thicknesses.

Turning back to FIG. 1, in examples, the first transponder 105 includes controller 130, optical module 135, and output port(s) 160. In some examples, the optical module 135 includes lasers 140a and 140b, and optical amplifiers 145a and 145b. The controller 130 controls operations of the first transponder 105, including controlling operations of the lasers 140a and 140b as well as the optical amplifiers 145a and 145b. The laser 140a and the optical amplifier 145a respectively generates and optically amplifies data signal 150 at a first wavelength (or wavelength range) 21, while the laser 140b and the optical amplifier 145b respectively generates and optically amplifies an OSC signal 155 at a second wavelength λ2. In examples, the second wavelength λ2 is separated from the first wavelength λ₁ by at least a threshold wavelength separation, such that the second wavelength is less than the first wavelength (i.e., λ₂<λ₁) or greater than the first wavelength (i.e., λ₂>λ₁), such as where:
(1) the first wavelength λ₁ lies at or near a middle portion of an optical wavelength transmission band and the second wavelength λ₂ lies at or near either an upper end or a lower end of the same optical wavelength transmission band; or
(2) the first wavelength λ₁ lies within a first optical wavelength transmission band and the second wavelength λ₂ lies within another optical wavelength transmission band.

In some examples, the second wavelength is separated from the first wavelength by at least a threshold wavelength separation, such that the second wavelength is much less than the first wavelength (i.e., λ₂<<λ₁) or much greater than the first wavelength (i.e., λ₂>>λ₁), such as one or more of the following:
(a) the first wavelength λ₁ and the second wavelength λ₂ lie at opposite ends of a single or same optical wavelength transmission band;
(b) the first wavelength λ₁ lies within a first optical wavelength transmission band and the second wavelength λ₂ lies within an adjacent optical wavelength transmission band; or
(c) the first wavelength λ₁ and the second wavelength λ₂ lie within respective optical wavelength transmission bands that are separated by one or more other optical wavelength transmission bands.

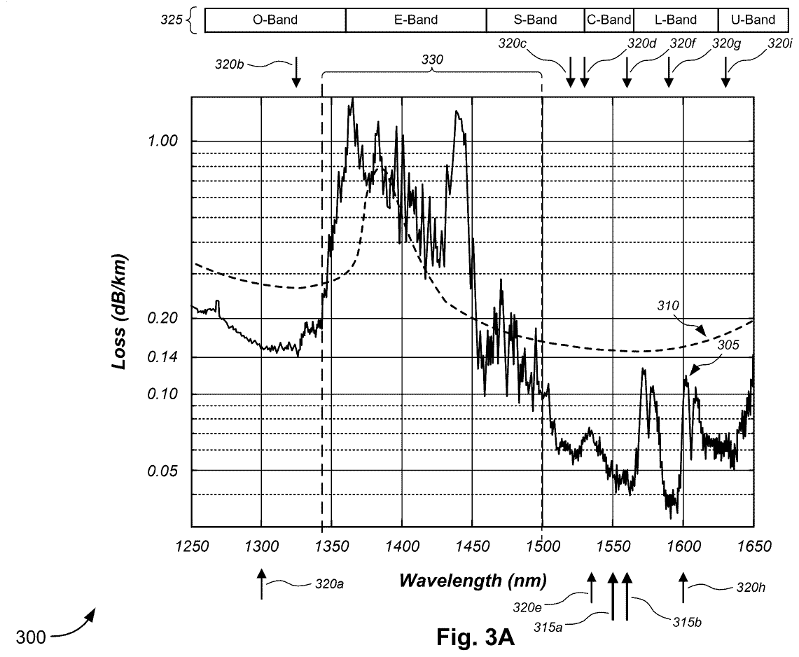

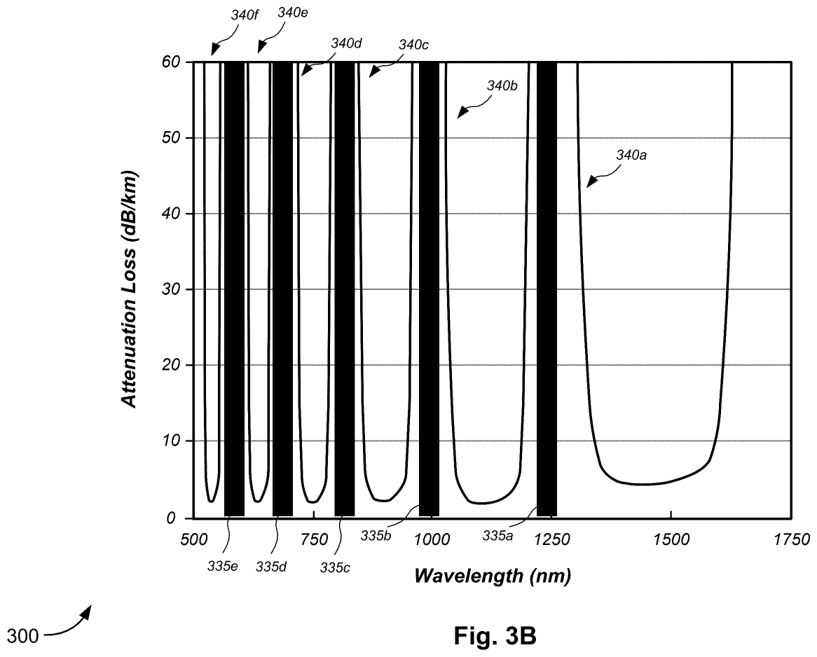

In some examples, each of the optical wavelength transmission bands referred to above includes one of an 850 nanometer (nm) Band, an original band (“O-Band”), an extended band (“E-Band”), a short band (“S-Band”), a conventional band (“C-Band”), a long band (“L-Band”), or an ultralong band (“U-Band”), in sequential order of optical wavelength transmission bands, as shown, e.g., in FIG. 3A. The 850 nm Band covers transmission of signals at a wavelength of 850 nm. The O-Band covers transmission of signals at wavelengths between about 1260 and about 1360 nm. The E-Band covers transmission of signals at wavelengths between about 1360 and about 1460 nm. The S-Band covers transmission of signals at wavelengths between about 1460 and about 1530 nm. The C-Band covers transmission of signals at wavelengths between about 1530 and about 1565 nm. The L-Band covers transmission of signals at wavelengths between about 1565 and about 1625 nm. The U-Band covers transmission of signals at wavelengths between about 1625 and about 1675 nm.

As shown in FIG. 1, the at least one HCF cable 115 includes a single HCF cable over which the data signal 150 at the first wavelength λ₁ and the OSC signal 155 at the second wavelength λ₁ are carried after being combined as a combined signal and output by output port(s) 160 at the first transponder 105. In examples, the OSC signal 155 corresponds to diagnostic data associated with operation of the OLS. In some examples, the OSC signal 155 carries at least one of (a) information regarding the optical data traffic transmitted between the first and second transponders; and/or (b) remote software upgrade data and network management information. The combined signal is subsequently received by input port(s) 175 at the second transponder 110. In examples, the second transponder 110 includes controller 170, the input port(s) 175, and optical module 180. In examples, the optical module 180 includes filters 185a and 185b, and photodetectors 190a and 190b. Like controller 130 of the first transponder 105, controller 170 of the second transponder 110 controls operations of the second transponder 110, including controlling operations of the filters 185a and 185b as well as the photodetectors 190a and 190b. The filter 185a and the photodetector 190a respectively filters and detects data signal 150 at the first wavelength λ₁, while the filter 185b and the photodetector 190b respectively filters and detects OSC signal 155 at the second wavelength λ₂.

Although not shown in FIG. 1, the first transponder 105 further includes filters and photodetectors (similar to filters 185a/185b and photodetectors 190a/190b of the second transponder 110) that are used by the first transponder 105 to filter and detect incoming data signals and OSC signals that correspond to the data signal 150 and the OSC signal 155, respectively. After receiving the incoming data signals, the controller causes the lasers 140a/140b to generate the data signal 150 and the OSC signal 155 based on the incoming data signals and OSC signals. Similarly, although not shown in FIG. 1, the 2 transponder 110 further includes lasers and optical amplifiers (similar to lasers 140a/140b and optical amplifiers 145a/145b) that are used by the second transponder 110 to generate and optically amplify the data signal 150 and the OSC signal 155 for transmission to another transponder. Alternatively or additionally, each of the first and second transponders 105 and 110, respectively, may further include routers or switches that receive data network signals and multiplexers/demultiplexers that multiplex the data network signals into the data signal 150 and demultiplex the data signal into subsequent data network signals, respectively. Although FIG. 1 depicts transmission of data signal 150 and OSC signal 155 (e.g., as a combined signal) in one direction from the first transponder 105 to the second transponder 110, system 100 can also be operated to transmit data signals and OSC signals in the opposite direction from the second transponder 110 to the first transponder 105, thus achieving bi-directional data transmission. For bi-directional data transmission, the second transponder 110 may further include an output port(s) and an optical module (like output port(s) 160 and optical module 135 of the first transponder 105), while the first transponder may further include an input port(s) and an optical module (like input port(s) 175 and optical module 180 of the second transponder 110), as well as a second HCF cable(s) to carry the data signals and the OSC signals. In some cases, an optical amplifier (like optical amplifier 165) is also used partway along the HCF cable(s) 115 to amplify the data signals and the OSC signals.

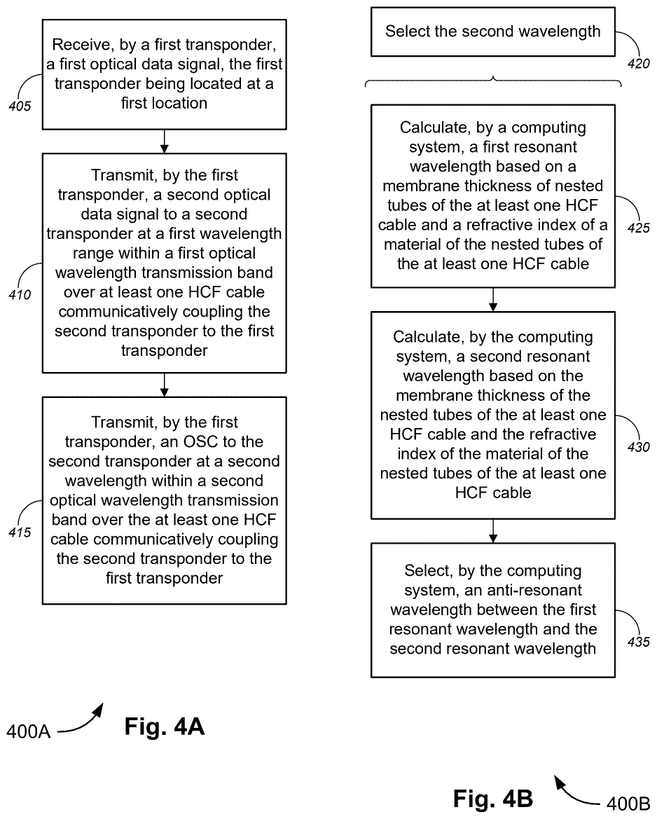

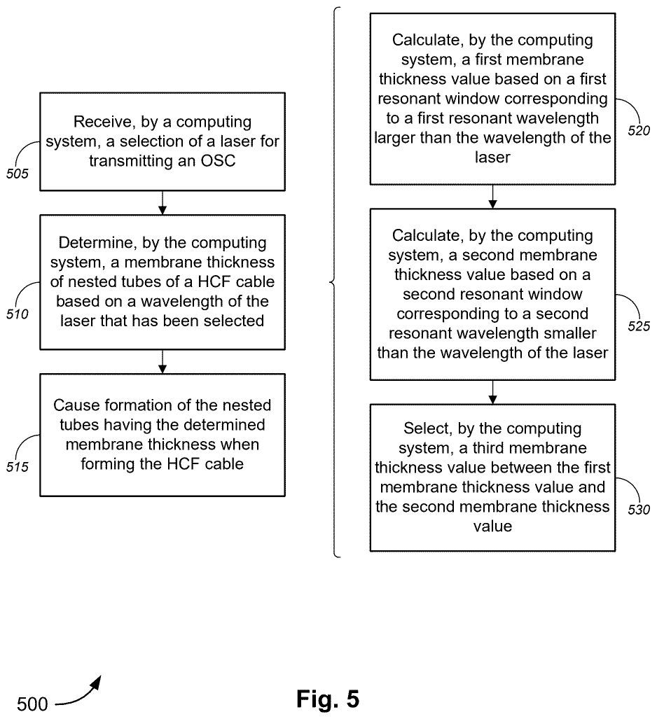

In examples, system 100A further includes computing system 195 that is used to determine, calculate, or select the second wavelength λ₂ at which the OSC signal 155 is transmitted by the first transponder, as described in detail below with respect to FIGS. 4B and 5. In some examples, the computing system 195 is also used to determine membrane thickness t₁ of the nested tubes 120, with the determined membrane thickness being used when manufacturing the at least one HCF cable 115, as described in detail below with respect to FIG. 5. In examples, the computing system 195 is remote from either the first transponder 105 or the second transponder 110. Alternatively, in examples, the second wavelength λ₂ is preselected, e.g., at a value that corresponds to a center wavelength at which a measured loss is low (such as shown in the loss measurement graph of FIG. 3A). The membrane thickness, in some examples, is also preselected or otherwise based on a predetermined manufacturing process.

FIGS. 2A-2D depict cross-sectional views of various example configurations 200A-200D of HCF cables when implementing an HCF-based line-system with an out-of-band optical supervisory channel. In the example configuration 200A of FIG. 2A, HCF cable 205a includes a plurality of nested tubes 210a (in this case five sets of nested tubes 210a) formed on an inner surface 215a of the HCF cable 205a. In some examples, such as shown in FIG. 2A, each set of nested tubes has a hollow tube 225 nested within hollow tube 220. A membrane of each hollow tube 220 or 225 is formed having a thickness 13. In some cases, the thicknesses of hollow tubes 220 and 225 are the same. In other cases, the thickness of hollow tube 220 is different from the thickness of hollow tube 225. In the example configuration 200B of FIG. 2B, HCF cable 205b includes a plurality of nested tubes 210b (in this case five sets of nested tubes 210b) formed on an inner surface 215b of the HCF cable 205b. In some examples, such as shown in FIG. 2B, each set of nested tubes has a hollow tube 240 nested within hollow tube 235, which is in turn nested within hollow tube 230. A membrane of each hollow tube 230, 235, or 240 is formed having a thickness 14. In some cases, the thicknesses of hollow tubes 230, 235, or 240 are the same. In other cases, the thickness of each of hollow tubes 230, 235, and 240 is different from the thickness of other ones of hollow tubes 230, 235, or 240. In the example configuration 200C of FIG. 2C, HCF cable 205c includes a plurality of nested tubes 210c (in this case six sets of nested tubes 210c) formed on an inner surface 215c of the HCF cable 205c. In some examples, such as shown in FIG. 2C, each set of nested tubes has a hollow tube 250 nested within hollow tube 245. A membrane of each hollow tube 245 or 250 is formed having a thickness 15. In some cases, the thicknesses of hollow tubes 245 and 250 are the same. In other cases, the thickness of hollow tube 245 is different from the thickness of hollow tube 250. In the example configuration 200D of FIG. 2D, HCF cable 205d includes a plurality of tubular elements 210d (in this case six sets of tubular elements 210d) formed on an inner surface 215d of the HCF cable 205d. In some examples, such as shown in FIG. 2D, each set of tubular elements has a hollow tube 255. A membrane of each hollow tube 255 is formed having a thickness t₆.

Given a wavelength over which data signals or OSC signals are to be transmitted, membrane thickness t (such as t₁-t₆ of FIGS. 1-2D) can be determined based on the following equation (although not limited to this equation):

$$t = \frac{m \cdot {λ}_{m}}{2 \cdot \sqrt{( {n}^{2} - 1 )}} \qquad ( Eqn . 1 )$$

where m is an integer (e.g., m=1, 2, 3, . . . ) and n is a refractive index of the material of the HCF cable (e.g., silica).

Conversely, given the membrane thickness t and a refractive index n of the HCF cable material, resonant wavelength can be determined based on the following equation (although not limited to this equation):

$${λ}_{m} = \frac{2 t}{m} \sqrt{( {n}^{2} - 1 )} \qquad ( Eqn . 2 )$$

The singular thickness and/or wavelength that result from these equations may be a central or target point about which a resonant window is formed. Similarly, anti-resonant windows exist between the resonant windows.

As used herein, resonant wavelength corresponds to a wavelength of light that couples with a material of the HCF cable. By contrast, an anti-resonant wavelength corresponds to a wavelength of light that propagates along a hollow core portion of the HCF cable without coupling (or minimal coupling) with the material of the HCF cable. For an HCF that is made of silica (e.g., silica having refractive index of 1.4444) and with a known membrane thickness of 500 nm, integer values m=1, 2, and 3 of the corresponding resonant wavelengths for the HCF cable are as follows: 1042 nm, 521 nm, and 347 nm (according to Eqn. 2). Except for the fundamental window (e.g., the n=1 case), anti-resonant wavelengths lie within anti-resonant windows between these resonant wavelengths at their corresponding integer values. The fundamental window (where n=1) is defined by a resonant window at the short wavelength edge (also referred to herein as a first wavelength edge; e.g., <1.5 μm) and by loss due to leakage, material absorption, and/or microbend losses, etc., at the long wavelength edge (also referred to herein as a second wavelength edge; e.g., >1.5 μm). FIG. 3B depicts anti-resonant windows relative to resonant windows. For a similar HCF cable having membrane thickness of 700 nm, for example, the corresponding resonant wavelengths (with anti-resonant wavelengths therebetween), for integer values m=1, 2, and 3, are as follows: 1459 nm, 730 nm, and 486 nm. For a similar HCF cable having membrane thickness of 800 nm, for example, the corresponding resonant wavelengths (with anti-resonant wavelengths therebetween), for integer values m=1, 2, and 3, are as follows: 1668 nm, 834 nm, and 556 nm. In some examples, given a choice of signal wavelength (or a range of wavelengths, e.g., C-band), and/or OSC wavelength (or potentially OSC wavelengths) a choice of membrane thickness and m values are identified (in some cases, using Eqn. 1 or 2) to ensure that the signal and OSC channels are well away from resonant wavelengths, and in sufficiently wide anti-resonant windows to ensure low losses for the signal and OSC wavelengths. In an example, OSC and data wavelengths are operated in the first anti-resonant window.

In other examples, given a wavelength of a laser for use to transmit the data signal or the OSC signal, a membrane thickness t can be determined using Eqn. 1 as follows. A first membrane thickness value is first calculated based on a first resonant window corresponding to a first resonant wavelength larger than the wavelength of the laser. Next, a second membrane thickness value is calculated based on a second resonant window corresponding to a second resonant wavelength smaller than the wavelength of the laser. In an example, the membrane thickness t is then calculated by selecting a third membrane thickness value between the first membrane thickness value and the second membrane thickness value, the third membrane thickness value corresponding to an anti-resonant window that lies between the first resonant window and the second resonant window. In other examples, detailed simulations involving a number of parameters are used to establish an optimum fiber structure (e.g., thickness and geometry of the HCF cable) to minimize loss at the signal and/or OSC wavelengths, the thickness and geometry including tube sizes and thicknesses, core size and thickness, a number of tubes, a number of elements, etc. In an example, for a laser wavelength of 1300 nm, the first resonant wavelength and the second resonant wavelength are selected to be, e.g., 1400 nm and 1200 nm. The corresponding membrane thickness values, according to Eqn. 1, are: 672 nm and 576 nm, respectively. An example third membrane thickness value is 600 nm (selected between 672 nm and 576 nm), which corresponds to the membrane thickness t. A first HCF cable for transmitting data signals at a wavelength of 1550 nm can be manufactured with nested tubes having a membrane thickness of 750 nm. A second HCF cable for transmitting OSC signals at a wavelength of 1300 nm can be manufactured with nested tubes having a membrane thickness of 600 nm. In yet another example, for a laser wavelength of 632 nm (such as for a helium-neon or HeNe laser, which is an inexpensive laser), the first resonant wavelength and the second resonant wavelength are selected to be about 732 nm and 532 nm. The corresponding membrane thickness values, according to Eqn. 1, are: 351 nm and 255 nm, respectively. An example third membrane thickness value is 300 nm (selected between 351 nm and 255 nm), which corresponds to the membrane thickness t. In some cases, selecting the third membrane thickness value includes selecting a membrane thickness corresponding to a center wavelength at which measured loss is low (such as shown in the loss measurement graph of FIG. 3A).

FIG. 3A depicts an example graphical representation 300 illustrating loss measurement of an HCF compared with loss measurement of a solid core fiber, with respect to wavelength, while FIG. 3B depicts an example graphical representation illustrating resonant and anti-resonant windows. FIGS. 3A and 3B are intended to provide example graphical representations of loss measurements, and are not intended to be limited to the specific examples depicted. With reference to FIG. 3A, example graphical representation 300 includes loss curves 305 (depicted in FIG. 3A by solid line curve) and 310 (depicted in FIG. 3A by dashed line curve) corresponding to loss (in units of decibel per kilometer (dB/km)) versus wavelength (in units of nm) for an HCF cable and for a solid core fiber cable, respectively. In FIG. 3A, arrows 315a and 315b correspond to wavelengths (in this case, 1550 and 1560 nm, respectively) that may be selected at which data signals are to be sent over the HCF cable. As shown in FIG. 3A, these wavelengths correspond to low loss values of less than 0.05 dB/km (compared with loss values above 0.14 dB/km for the solid core fiber for the same wavelengths).

Similarly, in FIG. 3A, arrows 320a-320i correspond to wavelengths (in this case, 1300, 1325, 1520, 1530, 1560, 1590, 1600, and 1630, respectively) at which OSC signals are to be sent over the HCF cable. As shown in FIG. 3A, the wavelengths 1300 and 1325 nm correspond to low loss values of about 0.14 dB/km (compared with loss values above 0.20 dB/km for the solid core fiber for the same wavelengths). For examples in which the OSC and data signals are transmitted over different HCF cables, the OSC carrying HCF cable can be selected or produced based on the calculations for membrane thickness 1, as described above with respect to Eqn. 1 and FIGS. 2A-2D. For example, membrane thickness values of 600 nm may be selected for wavelengths of 1300 or 1325 nm. As further shown in FIG. 3A, the wavelengths 1520, 1530, 1560, 1590, 1600, and 1630 correspond to low loss values of less than 0.06 dB/km (compared with loss values above 0.14 dB/km for the solid core fiber for the same wavelengths). Based on the calculations for membrane thickness t, as described above with respect to Eqn. 1 and FIGS. 2A-2D, membrane thickness values of 750 nm may be selected for wavelengths of 1520, 1530, 1560, 1590, 1600, or 1630 nm. Moreover, as shown in FIG. 3A, the loss for the HCF cable (i.e., curve 305) at about 1300 or 1325 (corresponding to arrows 320a or 320b) is at the same or almost the same loss value (or attenuation) as that for the solid core fiber (i.e., curve 310) at about 1550 nm (in this case, about 0.15 dB/km).

With reference to optical wavelength transmission bands 325 including the O-Band, the E-Band, the S-Band, the C-Band, the L-Band, or the U-Band, in sequential order of optical wavelength transmission bands. The O-Band covers transmission of signals at wavelengths between about 1260 and about 1360 nm. The E-Band covers transmission of signals at wavelengths between about 1360 and about 1460 nm. The S-Band covers transmission of signals at wavelengths between about 1460 and about 1530 nm. The C-Band covers transmission of signals at wavelengths between about 1530 and about 1565 nm. The L-Band covers transmission of signals at wavelengths between about 1565 and about 1625 nm. The U-Band covers transmission of signals at wavelengths between about 1625 and about 1675 nm. Referring to FIG. 3A, wavelengths 1300 and 1325 nm (corresponding to arrows 320a and 320b) fall within the O-Band. Wavelengths between about 1340 and about 1500 nm (denoted by a wavelength range 330 bounded by long dashed vertical lines) correspond to loss values due to water vapor in the HCF cable and the solid core fiber cable.

Referring to FIG. 3B, example resonant windows are shown, including a first resonant window 335a at about 1250 nm, a second resonant window 335b at about 1000 nm, a third resonant window 335c at about 800 nm, a fourth resonant window 335d at about 700 nm, and a fifth resonant window 335c at about 600 nm. Also shown in FIG. 3B are example anti-resonant windows, including a first anti-resonant window 340a between 1250 nm and 1700 nm, a second anti-resonant window 340b between the first and second resonant windows, a third anti-resonant window 340c between the second and third resonant windows, a fourth anti-resonant window 340d between the third and fourth resonant windows, a fifth anti-resonant window 340e between the fourth and fifth resonant windows, and a sixth anti-resonant window 340f between about 500 nm and 600 nm.

FIGS. 4A and 4B depict an example method 400A for implementing a hollow core fiber-based line-system with an out-of-band optical supervisory channel and an example method 400B for selecting a wavelength over which to transmit an optical supervisory channel.

In the example of FIG. 4A, method 400A, at operation 405, includes a first transponder (e.g., first transponder 105 of FIG. 1) receiving a first optical data signal. In some examples, the first transponder is located at a first location. At operation 410, the first transponder transmits a second optical data signal (e.g., data signal 150 or 145b of FIG. 1) to a second transponder (e.g., second transponder 110 of FIG. 1) at a first wavelength (e.g., 21; or first wavelength range) within a first optical wavelength transmission band over at least one HCF cable (e.g., HCF cable(s) 115 of FIG. 1) communicatively coupling the second transponder to the first transponder over a first fiber path distance (e.g., distance d of FIG. 1, which is at least 60 km). In some examples, the distance d is one of about 50 km, about 60 km, about 70 km, about 80 km, about 90 km, about 100 km, about 110 km, about 120 km, about 130 km, about 140 km, about 150 km, about 175 km, about 200 km, about 225 km, about 250 km, about 275 km, about 300 km, about 325 km, about 350 km, about 375 km, about 400 km, about 425 km, about 450 km, about 475 km, about 500 km, about 550 km, about 600 km, about 650 km, about 700 km, about 750 km, about 800 km, about 850 km, about 900 km, about 950 km, about 1000 km, or greater. In some examples, the distance d ranges from about 15 km to about 60 km, from about 50 km to about 120 km, from about 60 km to about 120 km, from about 100 km to about 1000 km, or greater. The second optical data signal corresponds to the first optical data signal. In examples, the first transponder and the second transponder are part of an optical line system (“OLS”).

At operation 415, the first transponder transmits an OSC signal (e.g., OSC signal 155 of FIG. 1) to the second transponder at a second wavelength (e.g., 12) within a second optical wavelength transmission band over the at least one HCF cable communicatively coupling the second transponder to the first transponder. In examples, the OSC signal corresponds to diagnostic data associated with operation of the OLS. In some examples, the OSC signal carries at least one of (a) information regarding the optical data traffic transmitted between the first and second transponders; and/or (b) remote software upgrade data and network management information. In some examples, the second optical wavelength transmission band is separate from the first optical wavelength transmission band by at least a threshold wavelength separation (e.g., λ₂<<λ₁ or λ₂>λ₁). In examples, the second wavelength is preselected, e.g., at a value that corresponds to a center wavelength at which a measured loss is low (such as shown in the loss measurement graph of FIG. 3A). In other examples, the second wavelength is selected in accordance with method 400B as shown in, and described below with respect to, FIG. 4B.

In some examples, the first wavelength range lies at a middle portion of one of the 850 nm Band, the O-Band, the E-Band, the S-Band, the C-Band, the L-Band, or the U-Band, and the second wavelength lies at or near either an upper end or a lower end of the same optical wavelength transmission band. In an example, for an optical data signal and an OSC signal being transmitted over the C-Band, the optical data signal is transmitted at about 1550 nm, while the OSC signal is transmitted at about 1535 nm (at a lower end of the C-Band) or at about 1560 nm (at an upper end of the C-Band). Alternatively, the first wavelength range and the second wavelength lie at or near opposite ends of the one of the 850 nm Band, the O-Band, the E-Band, the S-Band, the C-Band, the L-Band, or the U-Band. In an example, for an optical data signal and an OSC signal being transmitted over the C-Band, the optical data signal is transmitted at about 1560 nm (at an upper end of the C-Band), while the OSC signal is transmitted at about 1530 nm (at a lower end of the C-Band), or vice versa. In another alternative example, the second wavelength lies within a second optical wavelength transmission band that is another of the 850 nm Band, the O-Band, the E-Band, the S-Band, the C-Band, the L-Band, or the U-Band. In examples, an optical data signal is transmitted at about 1550 nm (in the C-Band), while the OSC signal is transmitted at about 1300 nm (in the O-Band) or at about 1590 nm (in the L-Band). In yet another alternative example, the first wavelength range and the second wavelength lie within respective optical wavelength transmission bands that are adjacent optical wavelength transmission bands among the sequential order of optical wavelength transmission bands. In an example, an optical data signal is transmitted at about 1550 nm (in the C-Band), while the OSC signal is transmitted at about 1600 nm (in the L-Band) or at about 1520 nm (in the S-Band). In still another example, the first wavelength range and the second wavelength lie within respective optical wavelength transmission bands that are separated by one or more other optical wavelength transmission bands among the sequential order of optical wavelength transmission bands. In examples, an optical data signal is transmitted at about 1550 nm (in the C-Band), while the OSC signal is transmitted at about 1325 nm (in the O-Band) or at about 1630 nm (in the U-Band).

Alternatively, multimode propagation or coherent laser transmissions may be used along the OSC to further monitor complex optical network systems. For example, for a membrane thickness of about 700 nm, using silica with a refractive index of 1.4444, resonant wavelengths at integer values m=1, 2, and 3, according to Eqn. 2, include: 1459 nm, 730 nm, and 486 nm. Accordingly, anti-resonant windows between 730 and 1459 nm (e.g., at a wavelength of about 1300 nm) and between 486 and 730 nm (e.g., at a wavelength of about 632 nm) may be capitalized for multimode OSC, using lasers one at a laser wavelength of about 1300 nm and the other at a laser wavelength of about 632 nm. A laser at a laser wavelength of about 1550 nm can be used for the data traffic. Off-the-shelf lasers exist for emitting at these laser wavelengths (about 632 nm, about 1300 nm, and about 1550 nm). Accordingly, by setting the anti-resonant windows to match these laser wavelengths, lower operational costs may be achieved using the off-the-shelf lasers.

In an example, as shown in and described above with respect to FIG. 1, the at least one HCF cable includes a single HCF cable, where the optical data traffic and the OSC signals are multiplexed and transmitted over the single HCF cable. In some cases, the OSC signal co-propagates with the optical data traffic in the same direction along the single HCF cable. In other cases, the OSC signal counter-propagates along the single HCF cable in the opposite direction relative to the optical data traffic being transmitted along the single HCF cable. In another example, the at least one HCF cable includes a first HCF cable and a second HCF cable, where the optical data traffic is carried over the first HCF cable and the OSC is carried over the second HCF cable.

Turning to FIG. 4B, method 400B, at operation 420, includes selecting the second wavelength (e.g., 12) over which the OSC signal is transmitted. In examples, selecting the second wavelength (at operation 420) includes a computing system calculating a first resonant wavelength based on a membrane thickness of nested tubes of the at least one HCF cable and a refractive index of a material of the nested tubes of the at least one HCF cable (at operation 425). Selecting the second wavelength (at operation 420) further includes the computing system calculating a second resonant wavelength based on the membrane thickness of the nested tubes of the at least one HCF cable and the refractive index of the material of the nested tubes of the at least one HCF cable (at operation 430). Selecting the second wavelength (at operation 420) further includes the computing system selecting an anti-resonant wavelength between the first resonant wavelength and the second resonant wavelength (at operation 435).

FIG. 5 depicts an example method 500 of manufacturing a hollow core optical fiber for carrying an out-of-band optical supervisory channel. In the example of FIG. 5, method 500, at operation 505, includes a computing system receiving a selection of a laser for transmitting an OSC signal. In examples, selecting a laser includes selecting a laser wavelength, selecting a type of laser, or selecting model of laser. In some examples, the OSC signal is transmitted within an OLS, and the OSC signal corresponds to diagnostic data associated with operation of the OLS.

At operation 510, the computing system determines a membrane thickness of nested tubes of an HCF cable based on a wavelength of the laser that has been selected. Method 500 further includes causing formation of the nested tubes having the determined membrane thickness when forming the HCF cable (at operation 515). In examples, determining the membrane thickness of the nested tubes of the HCF cable (at operation 510) includes the computing system calculating a first membrane thickness value based on a first resonant window corresponding to a first resonant wavelength larger than the wavelength of the laser (at operation 520). Determining the membrane thickness of the nested tubes of the HCF cable (at operation 510) further includes the computing system calculating a second membrane thickness value based on a second resonant window corresponding to a second resonant wavelength smaller than the wavelength of the laser (at operation 525). Determining the membrane thickness of the nested tubes of the HCF cable (at operation 510) further includes the computing system selecting a third membrane thickness value between the first membrane thickness value and the second membrane thickness value (at operation 530). The third membrane thickness value corresponds to an anti-resonant window that lies between the first resonant window and the second resonant window. In examples, the first membrane thickness value and the second membrane thickness value are calculated based on a relationship between a refractive index of a material of the nested tubes of the HCF cable and a corresponding one of the first resonant wavelength and the second resonant wavelength. In some cases, selecting the third membrane thickness value (at operation 530) includes selecting a membrane thickness corresponding to a center wavelength at which measured loss is low (such as shown in the loss measurement graph of FIG. 3A).

While the techniques and procedures in methods 400A, 400B, and 500 are depicted and/or described in a certain order for purposes of illustration, it should be appreciated that certain procedures may be reordered and/or omitted within the scope of various embodiments. Moreover, while the methods 400, 500 may be implemented by or with (and, in some cases, are described below with respect to) the systems, examples, or embodiments 100A, 100B, 200A, 200B, 200C, 200D, and 300 of FIGS. 1, 2A, 2B, 2C, 2D, and 3, respectively (or components thereof), such methods may also be implemented using any suitable hardware (or software) implementation. Similarly, while each of the systems, examples, or embodiments 100A, 100B, 200A, 200B, 200C, 200D, and 300 of FIGS. 1, 2A, 2B, 2C, 2D, and 3, respectively (or components thereof), can operate according to the methods 400, 500 (e.g., by executing instructions embodied on a computer readable medium), the systems, examples, or embodiments 100A, 100B, 200A, 200B, 200C, 200D, and 300 of FIGS. 1, 2A, 2B, 2C, 2D, and 3 can each also operate according to other modes of operation and/or perform other suitable procedures.

As should be appreciated from the foregoing, the present technology provides multiple technical benefits and solutions to technical problems. For instance, providing an out-of-band OSC, particularly over a solid core fiber-based line-system generally raises multiple technical problems. For example, using OSC wavelengths selected to be too close to the data traffic wavelength makes it difficult to distinguish between the data signals and the OSC signal. On the other hand, using a farther-apart OSC wavelength (e.g., at 1310 nm, compared to the data signal wavelength, e.g., at 1550 nm) leads to greater attenuation due to loss from an increased impact of Rayleigh scattering in the glass core of the solid core fiber at shorter wavelengths. Alternatively or additionally, using the farther-apart OSC wavelength leads to use of a greater number of repeaters to offset greater attenuation, which increases in operational and infrastructure costs, as well as inefficiencies. The present technology provides a hollow core fiber-based line-system with an out-of-band OSC. With the use of HCFs, the OSC can operate at wavelengths sufficiently far from the data traffic carrying wavelengths (e.g., in an optical wavelength transmission band for the OSC compared with that for the data traffic) with the same or near same attenuation as the data traffic carrying wavelength ranges significantly simplifying the overall OSC system. In this manner, lower loss or attenuation can be achieved with OSC wavelengths being far-apart from the data traffic carrying wavelengths (e.g., about 1300 nm OSC wavelength compared with about 1550 nm data traffic carrying wavelength). In some examples, anti-resonant windows can be set to match laser wavelengths of commercially available lasers (e.g., off-the-shelf lasers), as described in detail below. Accordingly, lower operational costs may be achieved using such commercially available lasers. Overall system efficiencies (e.g., in the form of energy savings and reduced hardware requirements) can be achieved with the use of fewer repeaters compared with solid core fiber-based systems. Further, the present technology enables long distance (e.g., at least 60 km) fiber cables due to HCFs being capable of high optical power transmissions without incurring non-linearities, which solid core fiber-based systems are incapable of achieving due to high optical power resulting in non-linearities in solid core fibers, while too little power results in too much loss (e.g., 0.25 dB/km, or greater) for solid core fibers that are too long (e.g., greater than 60 km). Moreover, unlike solid core fiber-based systems that require repeaters (that involve terminating, reshaping, and regenerating a signal) for long distances, HCF-based systems at most may use optical amplifiers (which magnify signals without terminating the signals) for longer distances (e.g., 100 km or more). In this manner, use of repeaters is obviated, thereby avoiding additional costs in terms of equipment, installation, maintenance, and additional points of potential failure with the use of repeaters.

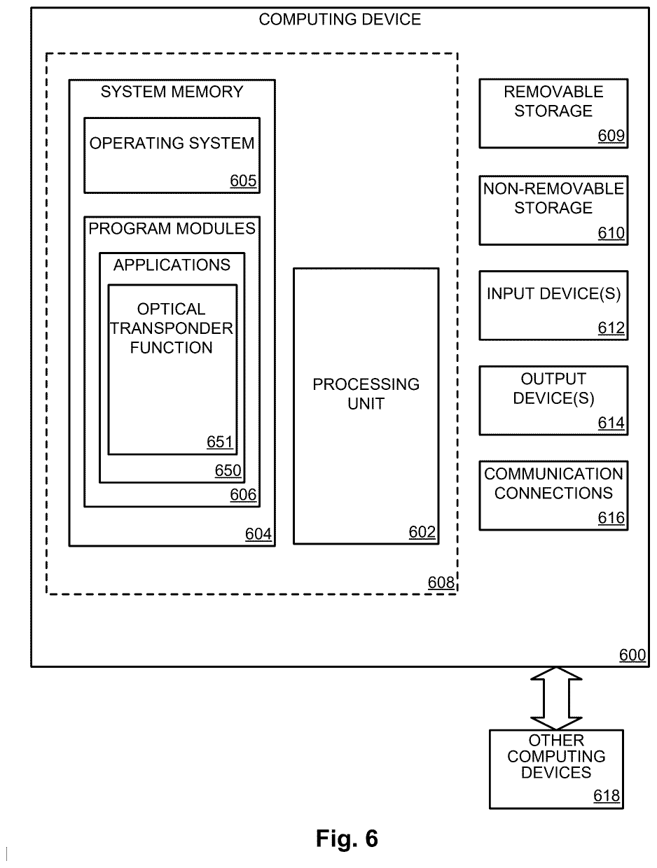

FIG. 6 depicts a block diagram illustrating physical components (i.e., hardware) of a computing device 600 with which examples of the present disclosure may be practiced. The computing device components described below may be suitable for a client device implementing the HCF-based line-system with the out-of-band optical supervisory channel, as discussed above. In a basic configuration, the computing device 600 may include at least one processing unit 602 and a system memory 604. The processing unit(s) (e.g., processors) may be referred to as a processing system. Depending on the configuration and type of computing device, the system memory 604 may include volatile storage (e.g., random access memory), non-volatile storage (e.g., read-only memory), flash memory, or any combination of such memories. The system memory 604 may include an operating system 605 and one or more program modules 606 suitable for running software applications 650, such as optical transponder function 651, to implement one or more of the systems or methods described above.

The operating system 605, for example, may be suitable for controlling the operation of the computing device 600. Furthermore, aspects of the invention may be practiced in conjunction with a graphics library, other operating systems, or any other application program and is not limited to any particular application or system. This basic configuration is illustrated in FIG. 6 by those components within a dashed line 608. The computing device 600 may have additional features or functionalities. For example, the computing device 600 may also include additional data storage devices (which may be removable and/or non-removable), such as, for example, magnetic disks, optical disks, or tape. Such additional storage is illustrated in FIG. 6 by a removable storage device(s) 609 and a non-removable storage device(s) 610.

As stated above, a number of program modules and data files may be stored in the system memory 604. While executing on the processing unit 602, the program modules 606 may perform processes including one or more of the operations of the method(s) as illustrated in FIGS. 4A-5, or one or more operations of the system(s) and/or apparatus(es) as described with respect to FIGS. 1-3, or the like. Other program modules that may be used in accordance with examples of the present disclosure may include applications such as electronic mail and contacts applications, word processing applications, spreadsheet applications, database applications, slide presentation applications, drawing or computer-aided application programs, artificial intelligence (“AI”) applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (“SOC”) where each or many of the components illustrated in FIG. 6 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 600 on the single integrated circuit (or chip). Examples of the present disclosure may also be practiced using other technologies capable of performing logical operations such as, for example, AND, OR, and NOT, including mechanical, optical, fluidic, and/or quantum technologies.

The computing device 600 may also have one or more input devices 612 such as a keyboard, a mouse, a pen, a sound input device, and/or a touch input device, etc. The output device(s) 614 such as a display, speakers, and/or a printer, etc. may also be included. The aforementioned devices are examples and others may be used. The computing device 600 may include one or more communication connections 616 allowing communications with other computing devices 618. Examples of suitable communication connections 616 include radio frequency (“RF”) transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 604, the removable storage device 609, and the non-removable storage device 610 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media may be non-transitory and tangible, and computer storage media do not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, communication media may include wired media such as a wired network or direct-wired connection, and wireless media such as acoustic, RF, infrared, and other wireless media.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A hollow core fiber-based line system with an out-of-band optical supervisory channel, the hollow core fiber-based line system comprising:
a first transponder located at a first location, the first transponder transmitting optical data traffic at a first wavelength range and transmitting an optical supervisory channel (“OSC”) signal at a second wavelength, the OSC signal carrying data signals corresponding to diagnostic data associated with transmission of the optical data traffic;
a second transponder located at a second location that is geographically separated from the first location; and
at least one hollow core fiber (“HCF”) cable communicatively coupling the second transponder to the first transponder over a first fiber path distance that is at least 60 kilometers, the at least one HCF cable carrying the optical data traffic and the OSC signal between the first and second transponders, the at least one HCF cable having a membrane thickness of nested tubes that cause at least one anti-resonant window at the first wavelength range and the second wavelength.

2. The hollow core fiber-based line system of claim 1, wherein the second wavelength corresponds to an anti-resonant window among a plurality of anti-resonant windows, wherein each anti-resonant window, other than a first anti-resonant window that is defined by a resonant window at a first wavelength edge and by loss due to optical leakage at a second wavelength edge, lies between two adjacent resonant windows among a plurality of resonant windows, wherein each resonant window corresponds to a wavelength of light that couples with a material of the at least one HCF cable and each anti-resonant window corresponds to a wavelength of light that propagates along a hollow core portion of the at least one HCF cable without coupling with the material of the at least one HCF cable.

3. The hollow core fiber-based line system of claim 1, wherein the first and second sets of wavelengths being separated by at least a threshold wavelength separation, wherein the first wavelength range lies within a first optical wavelength transmission band that is one of an 850 nm Band, an original band (“O-Band”), an extended band (“E-Band”), a short band (“S-Band”), a conventional band (“C-Band”), a long band (“L-Band”), or an ultralong band (“U-Band”), in sequential order of optical wavelength transmission bands.

4. The hollow core fiber-based line system of claim 3, wherein the first wavelength range and the second wavelength lie at opposite ends of the one of the 850 nm Band, the O-Band, the E-Band, the S-Band, the C-Band, the L-Band, or the U-Band.

5. The hollow core fiber-based line system of claim 3, wherein the second wavelength lies within a second optical wavelength transmission band that is another of the 850 nm Band, the O-Band, the E-Band, the S-Band, the C-Band, the L-Band, or the U-Band.

6. The hollow core fiber-based line system of claim 3, wherein the first wavelength range and the second wavelength lie within respective optical wavelength transmission bands that are adjacent optical wavelength transmission bands among the sequential order of optical wavelength transmission bands.

7. The hollow core fiber-based line system of claim 3, wherein the first wavelength range and the second wavelength lie within respective optical wavelength transmission bands that are separated by one or more optical wavelength transmission bands among the sequential order of optical wavelength transmission bands.

8. The hollow core fiber-based line system of claim 1, wherein the at least one HCF cable includes a first HCF cable, wherein the optical data traffic and the OSC signal are multiplexed and transmitted over the first HCF cable.

9. The hollow core fiber-based line system of claim 1, wherein the OSC signal carries at least one of:
information regarding the optical data traffic transmitted between the first and second transponders; or
remote software upgrade data and network management information.

10. A computer-implemented method for implementing a hollow core fiber-based line-system with an out-of-band optical supervisory channel, the method comprising:
receiving, by a first transponder of an optical line system (“OLS”), a first optical data signal, the first transponder being located at a first location;
transmitting, by the first transponder, a second optical data signal to a second transponder at a first wavelength range within a first optical wavelength transmission band over at least one hollow core fiber (“HCF”) cable communicatively coupling the second transponder to the first transponder over a first fiber path distance that is at least 60 kilometers, the second optical data signal corresponding to the first optical data signal; and
transmitting, by the first transponder, an optical supervisory channel (“OSC”) signal to the second transponder at a second wavelength within a second optical wavelength transmission band over the at least one HCF cable communicatively coupling the second transponder to the first transponder, the OSC signal corresponding to diagnostic data associated with operation of the OLS, wherein the first and second wavelengths each corresponds to an anti-resonant window that lies between two adjacent resonant windows, wherein each resonant window corresponds to a wavelength of light that couples with a material of the at least one HCF cable and each anti-resonant window corresponds to a wavelength of light that propagates along a hollow core portion of the at least one HCF cable without coupling with the material of the at least one HCF cable.

11. The computer-implemented method of claim 10, wherein the first optical wavelength transmission band is one of an 850 nm Band, an original band (“O-Band”), an extended band (“E-Band”), a short band (“S-Band”), a conventional band (“C-Band”), a long band (“L-Band”), or an ultralong band (“U-Band”), in sequential order of optical wavelength transmission bands, wherein the second optical wavelength transmission band is another of the 850 nm Band, the O-Band, the E-Band, the S-Band, the C-Band, the L-Band, or the U-Band, wherein the second optical wavelength transmission band is separate from the first optical wavelength transmission band by at least a threshold wavelength separation.

12. The computer-implemented method of claim 11, wherein the first wavelength range and the second wavelength lie within respective optical wavelength transmission bands that are adjacent optical wavelength transmission bands among the sequential order of optical wavelength transmission bands.

13. The computer-implemented method of claim 11, wherein the first wavelength range and the second wavelength lie within respective optical wavelength transmission bands that are separated by one or more optical wavelength transmission bands among the sequential order of optical wavelength transmission bands.

14. The computer-implemented method of claim 10, wherein the OSC signal carries at least one of:
information regarding optical data traffic transmitted between the first and second transponders; or
remote software upgrade data and network management information.

15. The computer-implemented method of claim 14, wherein the at least one HCF cable includes a first HCF cable and a second HCF cable, wherein the optical data traffic is carried over the first HCF cable and the OSC signal is carried over the second HCF cable.

16. A method of manufacturing a hollow core optical fiber for carrying an out-of-band optical supervisory channel, the method comprising:
receiving, by a computing system, a selection of a laser for transmitting an optical supervisory channel (“OSC”) signal within an optical line system (“OLS”), the OSC signal corresponding to diagnostic data associated with operation of the OLS;
determining, by the computing system, a membrane thickness of nested tubes of a hollow core fiber (“HCF”) cable based on a wavelength of the laser that has been selected; and
causing formation of the nested tubes having the determined membrane thickness.

17. The method of claim 16, wherein determining the membrane thickness of the nested tubes of the HCF cable includes:
calculating, by the computing system, a first membrane thickness value based on a first resonant window corresponding to a first resonant wavelength larger than the wavelength of the laser;
calculating, by the computing system, a second membrane thickness value based on a second resonant window corresponding to a second resonant wavelength smaller than the wavelength of the laser; and
selecting, by the computing system, a third membrane thickness value between the first membrane thickness value and the second membrane thickness value, the third membrane thickness value corresponding to an anti-resonant window that lies between the first resonant window and the second resonant window.

18. The method of claim 17, wherein the first membrane thickness value and the second membrane thickness value are calculated based on a relationship between a refractive index of a material of the nested tubes of the HCF cable and a corresponding one of the first resonant wavelength and the second resonant wavelength.

19. The method of claim 17, wherein selecting the third membrane thickness value includes selecting a membrane thickness corresponding to a center wavelength at which measured loss is low.
